(19) United States
(12) Patent Application Publication
(10) Pub. No.: US 2020/0047727 A1
(43) Pub. Date: Feb. 13, 2020

(54) VEHICLE BRAKING DEVICE

(71) Applicant: HONDA MOTOR CO., LTD., Tokyo (JP)

(72) Inventor: Takashi SHIMADA, Wako-shi (JP)

(21) Appl. No.: 16/534,211

(22) Filed: Aug. 7, 2019

(30) Foreign Application Priority Data
Aug. 8, 2018 (JP) 2018-149318

(51) Int. Cl. B60T 8/17; B60T 7/22; B60T 13/62; B60T 13/66; B60T 13/68

(52) U.S. Cl. CPC B60T 8/17; B60T 7/22; B60T 13/62; B60T 13/662; B60T 1/065; B60T 2270/402; B60T 2270/10; B60T 2270/30; B60T 13/686

(57) ABSTRACT

A vehicle braking device includes a master cylinder device, a motor cylinder device, first and second shutoff valves (solenoid valves) of a normally-open type which are provided in piping tubes (hydraulic pressure passages) providing communication between the master cylinder device and the motor cylinder device and which operate to open or close the hydraulic pressure passages, and an integrated control unit which performs drive control to close the solenoid valves in response to a pressure rise request. When a pressure rise request is received from any requester, the integrated control unit sets a valve closing characteristic in the course of closing the solenoid valves from the time of reception of the pressure rise request such that the valve closing characteristic for the pressure rise request issued by a second group requester is gentler than the valve closing characteristic for the pressure rise request issued by a first group requester.

### BACKGROUND OF THE INVENTION

### 1. Field of the Invention

The present invention relates to a vehicle braking device which applies braking force to a vehicle.

### 2. Description of the Related Art

A hybrid vehicle, for example, employs a by-wire brake system which generates braking force by way of an electrical system in addition to a traditional brake system which applies braking force by way of a hydraulic system. Such a by-wire brake system converts an amount of operation of the brake pedal by a driver to an electric signal, and gives the electric signal to an electric actuator which drives pistons of a slave cylinder (hereinafter referred to as “the motor cylinder device”).

Then, with the driving of the pistons along with the activation of the electric actuator, a braking hydraulic pressure is generated in the motor cylinder device. The braking hydraulic pressure thus generated activates wheel cylinders to apply the braking force to the vehicle (for example, see a vehicle braking device in Japanese Patent Application Publication No. 2012-131438 (Patent Document 1)).

The vehicle braking device according to Patent Document 1 is capable of applying the braking force to a vehicle by way of an electrical system.

In the by-wire vehicle braking device according to Patent Document 1, solenoid valves of a type in which a plunger joined to a valve is driven to a valve-closed position against spring force by a return spring are provided in hydraulic pressure passages providing communication between a master cylinder and the motor cylinder device. A primary hydraulic pressure generated in the master cylinder in response to the braking operation by the driver is shut off by the solenoid valves, and a secondary hydraulic pressure according to the amount of operation of the brake pedal is generated in the motor cylinder device.

As a type of the solenoid valve, used is a normally-open type for the purpose of ensuring a failsafe. Thus, when the solenoid valves fall into an abnormal state, the hydraulic pressure passages are kept opened and the hydraulic pressure generated in the master cylinder activates the wheel cylinders via the solenoid valves and thereby applies braking force to the vehicle.

In order to close the solenoid valve of the normally-open type, power supply is needed to generate thrust force necessary to close the valve by holding the plunger, which receives the reaction force of the return spring, at the valve-closed position. In the case where the power is supplied to the solenoid valve, the plunger generates collision noise with a case when reaching the valve-closed position. In addition, in the case where the power supply is stopped to move the plunger back to the initial position, the plunger is moved by the spring force of the return spring and generates collision noise with the case when reaching the initial position.

In order to reduce such collision noise, the by-wire vehicle braking device according to Patent Document 1 is configured such that a control device which controls opening and closing of the solenoid valves according to a braking operation controls a duty ratio of current to be supplied to the solenoids for driving the plungers to the valve-closed positions in such a way that the duty ratio is first kept at a predetermined start-up duty ratio and then is reduced to a start-up decelerated duty ratio which is lower than the start-up duty ratio.

The by-wire vehicle braking device according to Patent Document 1 is capable of reducing collision sound (noise) associated with the movement of the solenoid valves by lowering the speed of the plungers at a time when the plungers reach the valve-closed positions.

In recent years, along with technical development of automatic driving and automatic parking, for example, an autonomous braking control function which autonomously performs braking control independently of a braking operation by a driver has been put into practical use. In order to implement the autonomous braking control function, the by-wire vehicle braking device according to Patent Document 1 performs control to shut the solenoid valves provided in the hydraulic pressure passages providing the communication between the master cylinder and the motor cylinder device.

Here, in the case of implementing a responsive braking control function which performs braking control in response to a braking operation by the driver, noise associated with closure of the solenoid valves occurs in response to the braking operation by the driver. In this case, even if the driver hears the noise associated with the closure of the solenoid valves, the driver tolerates the noise to some extent because the noise is caused by his/her own braking operation.

In contrast to this, in the case of implementing the autonomous braking control function, noise associated with closure of the solenoid valves occurs at unexpected (sudden) timing independent of a braking operation by the driver. For this reason, this case has a problem that the driver gets unpleasant feeling.

In addition, the occurrence frequency of noise associated with closure of the solenoid valves in implementing the autonomous braking control function tends to be higher than the occurrence frequency of noise associated with closure of the solenoid valves in implementing the responsive braking control function. For this reason, also from the viewpoint of the occurrence frequency, there is a strong demand to suppress noise associated with closure of the solenoid valves in implementing the autonomous braking control function.

### SUMMARY OF THE INVENTION

The present invention was made in light of the foregoing circumstances, and has an object to provide a vehicle braking device capable of suppressing as much as possible noise associated with closure of solenoid valves in implementing an autonomous braking control function.

In order to achieve the above object, the invention according to (1) provides a vehicle braking device which applies braking force to a host vehicle, and which includes: a master cylinder device which generates a primary hydraulic pressure according to a braking operation by a driver of the host vehicle; a motor cylinder device which generates a secondary hydraulic pressure according to target braking force by an operation of an electric actuator; a solenoid valve of a normally-open type which is provided in a hydraulic pressure passage providing communication between the master cylinder device and the motor cylinder device, and which operates to open or close the hydraulic pressure passage; and a control unit which performs drive control to close the solenoid valve in response to each pressure rise request, and has main features in which requesters to issue the pressure rise requests include a first group requester in a first group which requires relatively high responsiveness and a second group requester in a second group which tolerates relatively low responsiveness, and in which when a pressure rise request is received from any one of the first group requester and the second group requester, the control unit sets a valve closing characteristic in the course of closing the solenoid valve from a time of reception of the pressure rise request such that the valve closing characteristic for a pressure rise request issued by the second group requester is gentler than the valve closing characteristic for a pressure rise request issued by the first group requester.

The vehicle braking device according to the present invention is capable of suppressing as much as possible noise associated with closure of the solenoid valve in implementing an autonomous braking control function.

### BRIEF DESCRIPTION OF THE DRAWINGS

FIG. 1 is a configuration diagram illustrating an overview of a vehicle braking device according to an embodiment of the present invention;

FIG. 2 is a block diagram illustrating a configuration including peripheries of an ESB-ECU and an integrated ECU included in the vehicle braking device according to the embodiment of the present invention;

FIG. 3 is a flowchart for describing an operation of the vehicle braking device according to the embodiment of the present invention;

FIGS. 4A to 4F are time charts for describing an operation of the vehicle braking device according to an embodiment of the present invention;

FIGS. 5A to 5C are time charts for describing an operation of the vehicle braking device according to an embodiment of the present invention;

FIGS. 6A to 6C for describing an operation of the vehicle braking device according to an embodiment of the present invention;

FIGS. 7A to 7F are time charts for describing an operation of the vehicle braking device according to an embodiment of the present invention;

FIGS. 8A to 8C are time charts for describing an operation of the vehicle braking device according to an embodiment of the present invention;

FIGS. 9A to 9C are time charts for describing an operation of the vehicle braking device according to an embodiment of the present invention; and

FIGS. 10A to 10F for describing an operation of the vehicle braking device according to a modification of the embodiment of the present invention.

### DETAILED DESCRIPTION OF THE EMBODIMENTS

Hereinafter, a vehicle braking device according to the present invention is described in detail with reference to the drawings.

Note that, in principle, a common reference numeral is assigned to components having a common function or components having functions corresponding to each other in the drawings presented below. Moreover, for the sake of convenience of description, the size and shape of each component are schematically represented by deformation or exaggeration in some cases.

### General Description of a Vehicle Braking Device 11 According to the Present Invention

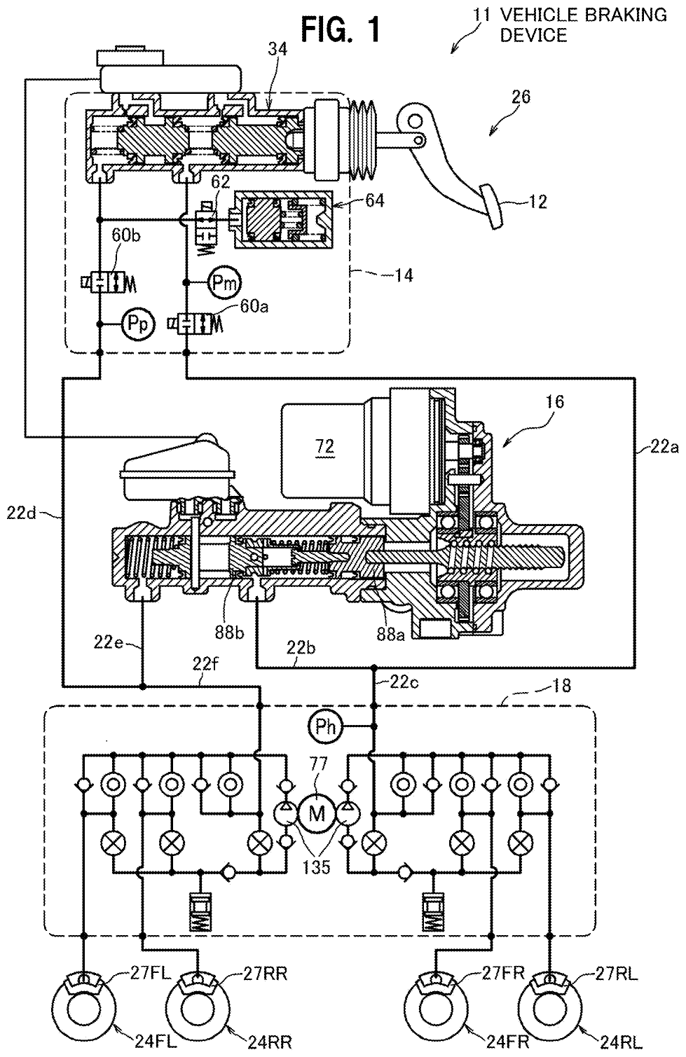

First of all, a vehicle braking device 11 according to an embodiment of the present invention is described in general with reference to FIG. 1. FIG. 1 is a configuration diagram illustrating an overview of the vehicle braking device 11 according to the embodiment of the present invention.

The vehicle braking device 11 according to the embodiment of the present invention includes a by-wire brake system which generates braking force by means of an electrical system in addition to a traditional brake system which generates braking force by means of a hydraulic system.

As illustrated in FIG. 1, the vehicle braking device 11 includes a master cylinder device 14, a motor cylinder device 16, a vehicle stability assist device 18 (hereinafter referred to as “the VSA device 18”; here, VSA is a registered trademark), hydraulic pressure control mechanisms 24FR, 24RL, 24RR, and 24FL, and so on.

Here, the hydraulic pressure control mechanisms 24FR, 24RL, 24RR, and 24FL are abbreviated to “the hydraulic pressure control mechanisms 24” when collectively described.

The master cylinder device 14 has a function to generate a primary hydraulic pressure according to a braking operation via a brake pedal 12 by a driver of a host vehicle (not-illustrated). In order to implement this function, the master cylinder device 14 includes a master cylinder 34 which converts the braking operation inputted by the driver via the brake pedal 12 to the primary hydraulic pressure, a stroke simulator 64 which creates pseudo reaction force to be applied to the brake pedal 12 pressed down by the driver, and first to third shutoff valves 60a, 60b and 62.

The first and second shutoff valves 60a and 60b correspond to “solenoid valves” of the present invention. The functions of the first and second shutoff valves 60a and 60b are described in detail later.

The motor cylinder device 16 has a function to generate a secondary hydraulic pressure according to target braking force (target braking torque) by an operation of a brake motor (electric actuator) 72. In order to implement this function, the motor cylinder device 16 includes a pair of slave pistons 88a and 88b which generate the secondary hydraulic pressure by receiving a rotary driving force by the brake motor 72.

The VSA device 18 has a function to assist the stabilization of the behavior of the host vehicle. More specifically, as illustrated in FIG. 1, the VSA device 18 functions to activate a pump motor 77 depending on the behavior of the host vehicle, and increase or decrease (adjust) the secondary hydraulic pressure by driving pumps 135 associated with this activation.

By exerting this function, the VSA device 18 periodically increases and decreases the secondary hydraulic pressure, and thereby achieves an ABS function to prevent the wheels from locking up in the braking operation, a traction control system (TCS) function to prevent the wheels from slipping during acceleration or the like, and a function to prevent the wheels from side-slipping during turning.

The hydraulic pressure control mechanisms 24 have a function to individually brake the respective four wheels (not illustrated) provided in the host vehicle. The hydraulic pressure control mechanisms 24 include calipers 27FR, 27RL, 27RR, and 27FL, respectively.

Here, the calipers 27FR, 27RL, 27RR, and 27FL are abbreviated to “the calipers 27” when collectively described.

The calipers 27 brake the four wheels by pressing both sides of discs (not illustrated) provided to the respective four wheels with the primary hydraulic pressure generated in the master cylinder device 14 or the secondary hydraulic pressure generated in the motor cylinder device 16.

Here, reference signs Pm, Pp, and Ph represent brake hydraulic pressure sensors which detect the pressure of the brake fluid flowing in predetermined portion of piping tubes 22a to 22f.

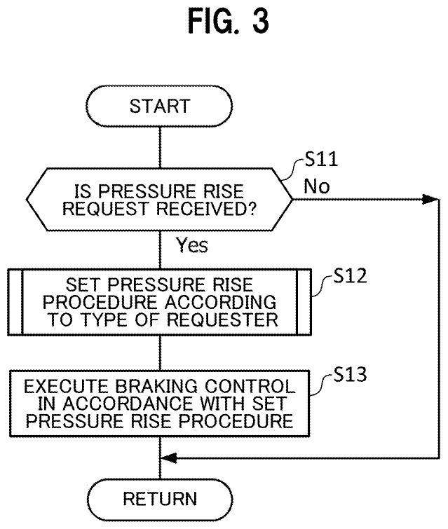

In the vehicle braking device 11 configured as described above, the first and second shutoff valves 60a and 60b are solenoid valves of a type in which a plunger joined to a valve is driven to a valve-closed position against spring force by a return spring (all of them are not-illustrated) as is the case of the valve described in Patent Document 1 (see FIG. 3 of Japanese Patent Application Publication No. 2012-131438).

The first and second shutoff valves 60a and 60b are provided in the piping tubes (hydraulic pressure passages) 22a and 22d providing communication between the master cylinder device 14 and the motor cylinder device 16. The first and second shutoff valves 60a and 60b are solenoid valves of a normally-open type which operate to open or close the piping tubes 22a and 22d, respectively.

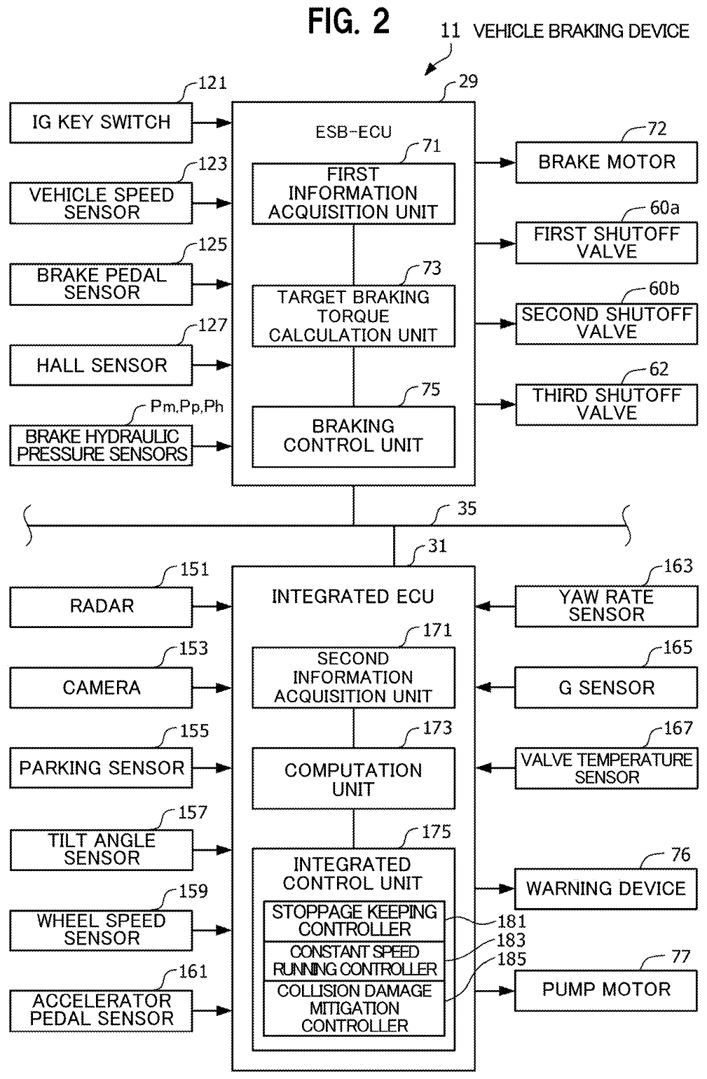

In the vehicle braking device 11, an integrated ECU 31 (see FIG. 2, which will be described in detail later) having received a pressure rise request causes the first and second shutoff valves 60a and 60b to shut off the primary hydraulic pressure generated in the master cylinder device 14 in response to a braking operation by the driver. At the same time, the integrated ECU 31 generates the secondary hydraulic pressure according to the amount of the braking operation by using the pump motor 77 of the motor cylinder device 16.

In short, in the vehicle braking device 11, the integrated ECU 31 having received the pressure rise request shuts (closes) the first and second shutoff valves 60a and 60b. Then, the primary hydraulic pressure is generated on the master cylinder device 14 side which is upstream of the first and second shutoff valves 60a and 60b thus shut, and the secondary hydraulic pressure is generated on the motor cylinder device 16 side which is downstream of the first and second shutoff valves 60a and 60b.

An operation of the vehicle braking device 11 in the case of receiving no pressure rise request is as follows. Specifically, the integrated ECU 31 having received no pressure rise request does not supply power to the first and second shutoff valves 60a and 60b. As a result, the first and second shutoff valves 60a and 60b are kept opened. Then, the primary hydraulic pressure generated on the master cylinder device 14 side, that is, the upstream side, in response to the braking operation by the driver is transmitted through the open first and second shutoff valves 60a and 60b to the motor cylinder device 16 side, that is, the downstream side.

The vehicle braking device 11 includes two systems of members which adjust the second hydraulic pressure while the integrated ECU 31 having received a pressure rise request is shutting the first and second shutoff valves 60a and 60b.

A first system adjusts the secondary hydraulic pressure by adjusting the slide positions of the pair of slave pistons 88a and 88b which are moved with a rotary driving force of the brake motor 72.

A second system adjusts the second hydraulic pressure by driving the pumps 135 along with the activation of the pump motor 77.

As for the function to adjust the secondary hydraulic pressure, it is generally known that the second system using the pump motor 77 achieves higher responsiveness than the first system using the brake motor 72.

The vehicle braking device 11 according to the present invention is described by taking an example in which the second system is mainly used to perform by-wire braking control in response to a pressure rise request from any of a first group requester (emergency braking requester) and a second group requester (steady braking requester), between which there is a wide range of difference in the requirement level of responsiveness.

Note that the first group requester (the emergency braking requester) and the second group requester (the steady braking requester) will be described in detail later.

### Basic Operation of the Vehicle Braking Device 11 According to the Embodiment of the Present Invention

Next, description is provided for a basic operation of the vehicle braking device 11 according to the embodiment of the present invention.

In the vehicle braking device 11 under the conditions where the motor cylinder device 16 is in normal operation and the integrated ECU 31 (see FIG. 2) which performs by-wire control is in normal operation, the by-wire brake system becomes active when the driver performs a braking operation by pressing down the brake pedal 12, for example.

The vehicle braking device 11 in the normal operation closes and shuts the first and second shutoff valves 60a and 60b and keeps the third shutoff valve 62 opened when the driver performs a braking operation (or the same occurs also when a pressure rise request is issued). The primary hydraulic pressure generated in the master cylinder 34 is let escape from the master cylinder 34 to the stroke simulator 64. As a result, even though the first and second shutoff valves 60a and 60b are shut, a buffer of the primary hydraulic pressure is generated to provide a stroke to the brake pedal 12 according to the braking operation by the driver.

In the vehicle braking device 11 in the normal operation, under the condition where the communication between the master cylinder device 14 and the motor cylinder device 16 is shut off by the first and second shutoff valves 60a and 60b, the secondary hydraulic pressure according to the braking operation by the driver is generated in the motor cylinder device 16 and the hydraulic pressure control mechanisms 24 are activated by using the secondary hydraulic pressure thus generated.

On the other hand, in the vehicle braking device 11 in abnormal operation in which the motor cylinder device 16 or the integrated ECU 31 does not operate normally, the traditional hydraulic brake system becomes active when the driver performs a braking operation.

The vehicle braking device 11 in the abnormal operation keeps the first and second shutoff valves 60a and 60b opened, while closing the third shutoff valve 62 when the driver performs a braking operation. The primary hydraulic pressure generated in the master cylinder 34 is transmitted to the hydraulic pressure control mechanisms 24 through the required piping tubes 22a to 22f, and activates the hydraulic pressure control mechanisms 24.

### Configuration including peripheries of an ESB-ECU 29 and the Integrated ECU 31 Included in the Vehicle Braking Device 11 According to the Embodiment of the Present Invention

Next, with reference to FIG. 2, description is provided for a configuration including peripheries of an electrical servo brake (ESB)-ECU 29 and the integrated ECU 31 included in the vehicle braking device 11 according to the embodiment of the present invention. FIG. 2 is a block diagram illustrating the configuration including the peripheries of the ESB-ECU 29 and the integrated ECU 31 included in the vehicle braking device 11 according to the embodiment of the present invention.

As illustrated in FIG. 2, the vehicle braking device 11 according to the embodiment of the present invention includes the ESB-ECU 29 and the integrated ECU 31.

As illustrated in FIG. 2, the ESB-ECU 29 and the integrated ECU 31 are connected to each other through a communication medium 35 such that they can perform information communication between them. As the communication medium 35, for example, a controller area network (CAN) constructed in the host vehicle may be preferably used. The CAN is a multiplexed serial communication network to be used for information communication between in-vehicle components.

### Configuration of the ESB-ECU 29

As illustrated in FIG. 2, to the ESB-ECU 29, connected is an input system including an ignition key switch (hereinafter abbreviated as “the IG key switch”) 121, a vehicle speed sensor 123, a brake pedal sensor 125, a hall sensor 127, and brake hydraulic pressure sensors Pm, Pp, and Ph.

The IG key switch 121 is a switch operated for supplying a power supply voltage to electrical components mounted on the host vehicle by means of an in-vehicle battery (not-illustrated). When the IG key switch 121 is turned on, the power supply voltage is supplied to the ESB-ECU 29 and the ESB-ECU 29 is started up.

The vehicle speed sensor 123 has a function to detect the vehicle speed of the host vehicle. Information on the vehicle speed detected by the vehicle speed sensor 123 is transmitted to the ESB-ECU 29.

The brake pedal sensor 125 has a function to detect an amount of operation (stroke volume) and load (pedaling force) on the brake pedal 12 by the driver. Information on the amount of operation and the load on the brake pedal 12 detected by the brake pedal sensor 125 is transmitted to the ESB-ECU 29.

Alternatively, the brake pedal sensor 125 may be a brake SW having a function to just detect ON (the brake pedal is pressed down) or OFF (the brake pedal is not pressed down).

The hall sensor 127 has a function to detect a rotation angle of the brake motor 72 (information on the current positions of the pair of slave pistons 88a and 88b in an axial direction). Information on the rotation angle of the brake motor 72 detected by the hall sensor 127 is transmitted to the ESB-ECU 29.

The brake hydraulic pressure sensors Pm, Pp, and Ph have functions to detect a hydraulic pressure on an upstream side of the first shutoff valve 60a, a hydraulic pressure on a downstream side of the second shutoff valve 60b, and a hydraulic pressure inside the VSA device 18, respectively, in the brake hydraulic pressure system. Information on the hydraulic pressures in the portions in the brake hydraulic pressure system detected by the brake hydraulic pressure sensors Pm and Pp is transmitted to the ESB-ECU 29. Then, information on the hydraulic pressure detected by the brake hydraulic pressure sensor Ph is transmitted to the integrated ECU 31 through the ESB-ECU 29 and the communication medium 35.

As illustrated in FIG. 2, to the ESB-ECU 29, connected is an output system including the brake motor 72 and the first to third shutoff valves 60a, 60b, and 62.

As illustrated in FIG. 2, the ESB-ECU 29 includes a first information acquisition unit 71, a target braking torque calculation unit 73, and a braking control unit 75.

The first information acquisition unit 71 has a function to acquire information such as information on an on/off operation of the IG key switch 121, information on the vehicle speed detected by the vehicle speed sensor 123, braking operation information on the amount of braking operation and the load detected by the brake pedal sensor 125, information on the rotation angle of the brake motor 72 detected by the hail sensor 127, information on the braking hydraulic pressures in the portions detected by the brake hydraulic pressure sensors Pm, Pp, and Ph.

The target braking torque calculation unit 73 basically has a function to calculate target braking torque (synonymous with target braking force) according to a requested braking amount based on the amount of the braking operation of the brake pedal 12.

The braking control unit 75 has a function to perform braking control to adjust the magnitude of the hydraulic braking torque such that the actual hydraulic braking torque follows the target braking torque based on the braking operation by the driver.

The ESB-ECU 29 is formed of a micro-computer including a central processing unit (CPU), a read only memory (ROM), a random access memory (RAM), and so on. This micro-computer reads programs and data stored in the ROM for execution, and thereby operates to perform execution control on various kinds of functions owned by the ESB-ECU 29, including the function to acquire various kinds of information, the function to calculate the target braking torque, and the function to perform the braking control to adjust the magnitude of the hydraulic braking torque.

### Configuration of the Integrated ECU 31

As illustrated in FIG. 2, to the integrated ECU 31, connected is an input system including a radar 151, a camera 153, a parking sensor 155, a tilt angle sensor 157, a wheel speed sensor 159, an accelerator pedal sensor 161, a yaw rate sensor 163, a G sensor 165, and a valve temperature sensor 167.

As the radar 151, for example, a laser radar, a microwave radar, a milliwave radar, an ultrasonic radar, or the like may be used as appropriate. The radar 151 is installed on the rear side of the front grille or the like of the host vehicle. Information on a target distribution around the host vehicle detected by the radar 151 is transmitted to the integrated ECU 31.

The camera 153 has an optical axis tilted obliquely downward while extending in front of the host vehicle and has a function to capture an image in a forward direction of the host vehicle. As the camera 153, for example, a complementary metal oxide semiconductor (CMOS) camera, a charge coupled device (CCD) camera, or the like may be used as appropriate. The camera 153 is installed on an upper center portion of the window shield or the like of the host vehicle. Information on the forward-direction image of the host vehicle captured by the camera 153 is transmitted to the integrated ECU 31 as an image signal generated in accordance with an interlacing scheme such as NTSC (National Television Standards Committee), for example.

The parking sensor 155 is installed, for example, at a front corner portion or in a rear bumper of the host vehicle, and has a function to detect the presence/absence of an obstacle and the distance to the obstacle. Information on the obstacle detected by the parking sensor 155 is transmitted to the integrated ECU 31.

The tilt angle sensor 157 has a function to detect an attitude (a tilt angle with respect to the horizontal) of the host vehicle. Information on the tilt angle detected by the tilt angle sensor 157 is transmitted to the integrated ECU 31.

The wheel speed sensor 159 has a function to detect the rotation speed (wheel speed) of each of the wheels mounted on the host vehicle. Information on the rotation speed (wheel speed) of each of the wheels detected by the wheel speed sensor 159 is transmitted to the integrated ECU 31.

The accelerator pedal sensor 161 has a function to detect an amount of operation (stroke volume) on the accelerator pedal by the driver. Information on the amount of operation on the accelerator pedal detected by the accelerator pedal sensor 161 is transmitted to the integrated ECU 31.

The yaw rate sensor 163 has a function to detect a yaw rate of yawing of the host vehicle. Information on the yaw rate detected by the yaw rate sensor 163 is transmitted to the integrated ECU 31.

The G sensor 165 has a function to detect a longitudinal g-force (G) (acceleration in the front-rear direction) and a lateral G (acceleration in a side-to-side direction) occurring in the host vehicle. The G information detected by the G sensor 165 is transmitted to the integrated ECU 31.

The valve temperature sensor 167 has a function to detect an atmosphere temperature of the first and second shutoff valves 60a and 60b. Information on the valve temperature of the first and second shutoff valves 60a and 60b detected by the valve temperature sensor 167 is transmitted to the integrated ECU 31.

In addition, as illustrated in FIG. 2, to the integrated ECU 31, connected is an output system including a warning device 76 and the pump motor 77.

The warning device 76 has a function to issue a warning by stimulating a sensation such as a hearing, viewing, or touching sensation of the driver in the case where a collision of the host vehicle with an obstacle is predicted or other cases.

For example, in the case where a collision of the host vehicle with an obstacle is predicted or other cases, the pump motor 77 is driven to rotate based on an electric signal generated by the integrated ECU 31 in order to mitigate a collision damage. The pump motor 77 mainly adjusts the secondary hydraulic pressure for increase or decrease by driving the pumps 135 (see FIG. 1) along with the rotary driving of the pump motor 77.

A second information acquisition unit 171 has a function to acquire the information on the target distribution detected by the radar 151, the information of the forward-direction image captured by the camera 153, the information on the obstacle detected by the parking sensor 155, the information on the tilt angle detected by the tilt angle sensor 157, the information on the wheel speeds detected by the wheel speed sensor 159, the information on the amount of acceleration/deceleration operation on the accelerator pedal detected by the accelerator pedal sensor 161, the information on the yaw rate detected by the yaw rate sensor 163, the G information detected by the G sensor 165, and the information on the valve temperature of the first and second shutoff valves 60a and 60b detected by the valve temperature sensor 167.

In addition, the second information acquisition unit 171 has a function to acquire the information on the vehicle speed detected by the vehicle speed sensor 123, and the information on the amount of braking operation and the load on the brake pedal 12 detected by the brake pedal sensor 125, which are transmitted from the ESB-ECU 25 though the CAN communication medium 35.

A computation unit 173 has a function to obtain a slip ratio (slip information) of each of the wheels by calculation based on the information on the vehicle speed and the information on the wheel speed of the wheel acquired by the second information acquisition unit 171.

The slip information of the wheels obtained by the computation unit 173 is referred to, as appropriate, by an integrated control unit 175 in the case where the integrated control unit 175 determines the necessity/unnecessity to activate the ABS control, and other cases.

In addition, the computation unit 173 has a function to obtain information for steady keeping a stoppage and a constant speed running state of the host vehicle by computation based on various kinds of information including the information on the vehicle speed detected by the vehicle speed sensor 123, the information on the amount of braking operation and the load of the brake pedal 12 detected by the brake pedal sensor 125, the information on the tilt angle detected by the tilt angle sensor 157, and the information on the wheel speeds detected by the wheel speed sensor 159.

The information for steady keeping the running state obtained by the computation unit 173 is referred to by a stoppage keeping controller 181 and a constant speed running controller 183 included in the integrated control unit 175 in the case where they perform steady braking control intended to steadily keep the stoppage and the constant speed running state of the host vehicle or other cases. The steady braking control performed by the stoppage keeping controller 181 and the constant speed running controller 183 will be described in detail later.

Moreover, the computation unit 173 has a function to obtain prediction information concerning a collision damage which the host vehicle may receive if the host vehicle hits an obstacle, based on various kinds of information including the information on the target distribution detected by the radar 151, the information of the forward-direction image captured by the camera 153, the information on the obstacle detected by the parking sensor 155, and the information on the vehicle speed detected by the vehicle speed sensor 123.

The prediction information concerning a collision damage obtained by the computation unit 173 is referred to by a collision damage mitigation controller 185 included in the integrated control unit 175 when the collision damage mitigation controller 185 performs emergency braking control intended to mitigate a collision damage. The emergency braking control performed by the collision damage mitigation controller 135 will be described in detail later.

The integrated control unit 175 basically determines the necessity/unnecessity to activate the ABS control based on information such as the information on the slip ratios of the wheels obtained by the computation unit 173. If the integrated control unit 175 determines that the ABS control needs to be activated as a result of this determination, the integrated control unit 175 performs braking control, by causing the VSA device 18 to exert the braking hydraulic pressure adjusting function, to periodically increase or decrease the braking force on each of the wheels such that the slips of the wheels can be suppressed.

The stoppage keeping controller 181 included in the integrated control unit 175 performs control to steadily keep the stopped host vehicle in the stopped state based on the information for steady keeping the stoppage of the host vehicle obtained by the computation unit 173 (such as information on whether the place of the stopped host vehicle is a flat road or a sloping road).

Here, the vehicle braking device 11 according to the embodiment of the present invention performs the control to steadily keep the stopped host vehicle in the stopped state, in accordance with a valve closing characteristic (valve closing speed) in the course of closing the first and second shutoff valves 60a and 60b (valve closure) from the time of reception of a pressure rise request. In this control, the valve closing characteristic (valve closing speed) is varied between the cases where the driver of the host vehicle stopped on a sloping road intends to start running and not to start running. This feature will be described in detail later.

The constant speed running controller 183 included in the integrated control unit 175 performs control such that the host vehicle running at constant speed is steadily kept in the constant speed running state, based on information for steady keeping the constant speed running of the host vehicle obtained by the computation unit 173 (such as information on the current vehicle speed and the set vehicle speed of the host vehicle).

The collision damage mitigation controller 185 included in the integrated control unit 175 performs the emergency braking control intended to mitigate a collision damage based on the prediction information concerning a collision damage of the host vehicle obtained by the computation unit 173 (such as information on a probability of collision of the host vehicle with an object, a remaining time until the host vehicle will collide with the object, a position which will collide with the object, and a type of the object).

The integrated ECU 31 is formed of a micro-computer including a central processing unit (CPU), a read only memory (ROM), a random access memory (RAM), and so on. This micro-computer reads programs and data stored in the ROM for execution, and thereby operates to perform execution control on various kinds of functions owned by the integrated ECU 31, including the function to acquire various kinds of information, the function to calculate the information for steady keeping the stoppage and the constant speed running state of the host vehicle, the function to calculate the prediction information concerning a collision damage which the host vehicle may receive in collision with an obstacle, the function to perform the control to steadily keep the stopped host vehicle in the stopped state, the function to perform control to steadily keep the running host vehicle in the constant speed running state, and the function to perform the emergency braking control intended to mitigate a collision damage.

### Multiple Pressure Rise Requesters Presumed by the Vehicle Braking Device 11 According to the Embodiment of the Present Invention

Next, multiple pressure rise requesters presumed by the vehicle braking device 11 according to the embodiment of the present invention are described in descending order of the time length of the valve closing characteristic in the course of closing the first and second shutoff valves 60a and 60b from the time of reception of a pressure rise request (in order from the lowest level of immediate responsiveness required) in the case where the pressure rise request is received from a pressure rise requester.

Among the multiple pressure rise requesters presumed by the vehicle braking device 11 according to the embodiment of the present invention, a hill start assist (hereinafter abbreviated as “HSA”) requires the lowest level of immediate responsiveness. The HSA is, for example, a function to hold the braking hydraulic pressure for a predetermined length of time in the case where the host vehicle stopped on a sloping road is supposed to move downward when the driver releases his/her foot from the brake pedal 12 to perform a starting operation.

Among the multiple pressure rise requesters, a brake hold assist (hereinafter abbreviated as “BHA”) requires the second lowest level of immediate responsiveness. The BHA is, for example, a function to hold the braking hydraulic pressure in the case where the host vehicle stopped on a sloping road is supposed to move backward when the driver releases his/her foot from the brake pedal 12.

The difference between the HSA and the BHA is that the HSA assists prevention of downward movement of the host vehicle along with a start operation, whereas the BHA assists the brake hold without a start operation.

Among the multiple pressure rise requesters, an adaptive cruise control (hereinafter abbreviated as “ACC”) requires the third lowest level of immediate responsiveness. The ACC is a function to adjust the braking hydraulic pressure for the purpose of steadily keeping a preset vehicle speed and inter-vehicle distance.

The difference between the HSA/BHA and the ACC is that the HSA/BHA restricts the start of movement of the host vehicle stopped on a sloping road, whereas the ACC adjusts the braking hydraulic pressure of the host vehicle during running.

Among the multiple pressure rise requesters, a parking assist system (hereinafter abbreviated as “PAS”) requires the second highest level of immediate responsiveness. The PAS is, for example, a function to try to avoid a collision or mitigate a collision damage by applying automatic braking (adjusting the braking hydraulic pressure) when the danger of collision of the host vehicle with an obstacle increases while the vehicle speed is low in a parking operation or the like.

Among the multiple pressure rise requesters, a collision damage mitigation brake system (hereinafter abbreviated as “CMBS”) requires the highest level of immediate responsiveness. The CMBS is, for example, a function to recognize a preceding vehicle by searching with the radar 151 and try to avoid a collision or mitigate a collision damage by applying automatic braking (adjusting the braking hydraulic pressure) when the danger of collision with the preceding vehicle increases.

The difference between the PAS and the CMBS is that the PAS tries to avoid a collision or mitigate a collision damage while the vehicle speed is relatively low, whereas the CMBS tries to avoid a collision or mitigate a collision damage of the host vehicle during running at a relatively high vehicle speed.

### Outline of an Operation of the Vehicle Braking Device 11 According to the Embodiment of the Present Invention

Next, with reference to FIG. 3, description is provided for an outline of an operation of the vehicle braking device 11 according to the embodiment of the present invention. FIG. 3 is a flowchart for describing the operation of the vehicle braking device 11 according to the embodiment of the present invention.

Here, the operation is performed on the premise that the IG key switch 121 is always kept on.

At step S11 in FIG. 3, the integrated control unit 175 in the integrated ECU 31 checks whether a pressure rise request is received from any of the multiple pressure rise requesters presumed by the vehicle braking device 11 according to the embodiment of the present invention.

The integrated control unit 175 in the integrated ECU 31 iterates the determination at step S11 until it is determined that a pressure rise request is received from any of the multiple pressure rise requesters.

If it is determined that the pressure rise request is received (Yes at step S11), the integrated control unit 175 in the integrated ECU 31 advances the processing sequence to next step S12.

At step S12, the integrated control unit 175 in the integrated ECU 31 sets a pressure rise procedure depending on the type of the requester having issued the pressure rise request. The pressure rise procedure depending on the type of the requester means, for example, a valve closing characteristic (for example, a valve closing time length or a valve closing speed) in the course of closing the first and second shutoff valves 60a and 60b (valve closure) from the time of reception of a pressure rise request. The pressure rise procedure depending on the type of the requester will be described in detail later. Thereafter, the integrated control unit 175 in the integrated ECU 31 advances the processing sequence to next step S13.

At step S13, the integrated control unit 175 in the integrated ECU 31 executes braking control in accordance with the pressure rise procedure thus set. After that, the integrated control unit 175 in the integrated ECU 31 advances the processing sequence to a return terminal.

The integrated control unit 175 in the integrated ECU 31 executes the braking control in accordance with the pressure rise procedure depending on the type of the requester.

Here, the braking control in accordance with the pressure rise procedure depending on the type of the requester means to, when a pressure rise request is received from any of the multiple pressure rise requesters presumed by the vehicle braking device 11 according to the embodiment of the present invention, set a valve closing characteristic (such as a valve closing time length or a valve closing speed) for the first and second shutoff valves 60a and 60b appropriate for the requester and execute the braking control using the setting according to this valve closing characteristic.

In the by-wire brake system, as described above, it is necessary to close and shut the first and second shutoff valves 60a and 60b before the secondary hydraulic pressure is generated by using the brake motor 72 and the pump motor 77 (the brake motor 72 and the pump motor 77 correspond to “an electric actuator” of the present invention) provided downstream of the first and second shutoff valves 60a and 60b.

This is because, if the first and second shutoff valves 60a and 60b are closed and shut after the secondary hydraulic pressure is generated on the downstream side of the first and second shutoff valves 60a and 60b, the brake fluid having the secondary hydraulic pressure generated on the downstream side may flow into the upstream side of the first and second shutoff valves 60a and 60b, and deteriorate brake feeling and brake control performance.

For this reason, in the related art, for the purpose of preventing a situation where the brake fluid having the secondary hydraulic pressure generated on the downstream side flows into the upstream side of the first and second shutoff valves 60a and 60b, the valve closing characteristic in the course of closing the first and second shutoff valves 60a and 60b (valve closure) from the time of reception of a pressure rise request is set so steep that the first and second shutoff valves 60a and 60b can be closed and shut also by taking into account the maximum pressure rising characteristic for the secondary hydraulic pressure on the downstream side.

As a result, the operation sound (noise) associated with the valve closure of the first and second shutoff valves 60a and 60b is large.

However, actually, it is not often the case that a sharp rise in the pressure is required when a pressure rise request is received. Nevertheless, in the related art, the valve closing characteristic in the course of closing the first and second shutoff valves 60a and 60b(valve closure) from the time of reception of a pressure rise request is set steep just for such a rare case requiring a sharp rise in the pressure.

To address this, in the vehicle braking device 11 according to the embodiment of the present invention, when a pressure rise request is received from any of the multiple pressure rise requesters presumed by the present invention, the valve closing characteristic (such as the valve closing time length or the valve closing speed) for the first and second shutoff valves 60a and 60b suitable for the requester is set and the braking control is executed by using the setting according to this valve closing characteristic, so that the operation sound (noise) associated with the valve closure of the first and second shutoff valves 60a and 60b can be suppressed as much as possible.

### Detailed Operations of the Vehicle Braking Device 11 According to Embodiments of the Present Invention

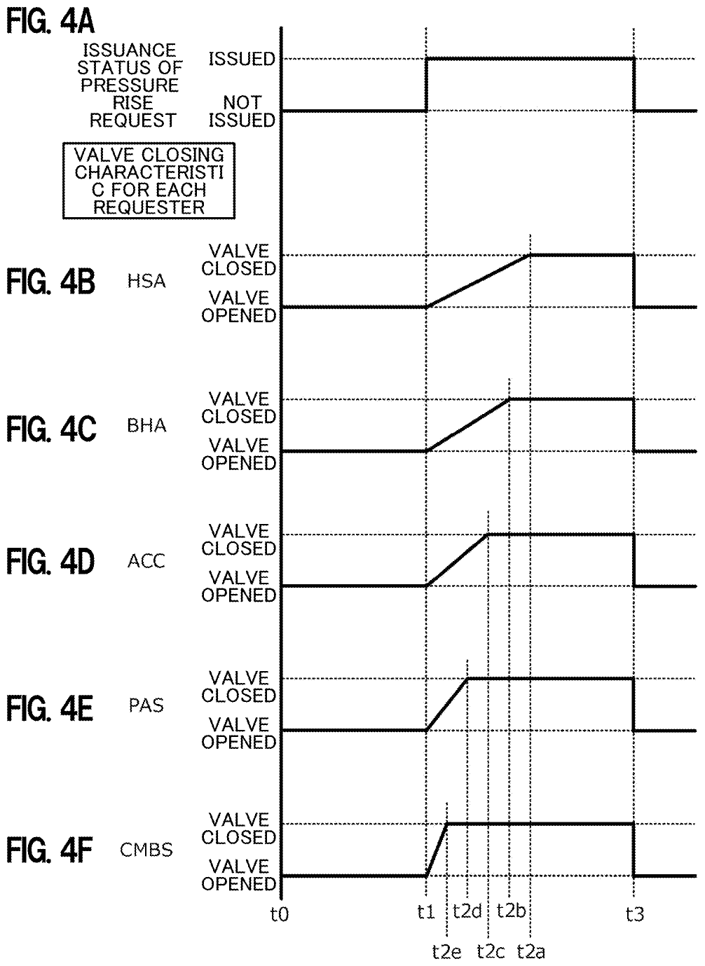

Next, description is provided for detailed operations of the vehicle braking device 11 according to embodiments of the present invention by referring to FIGS. 4A to 10F as needed.

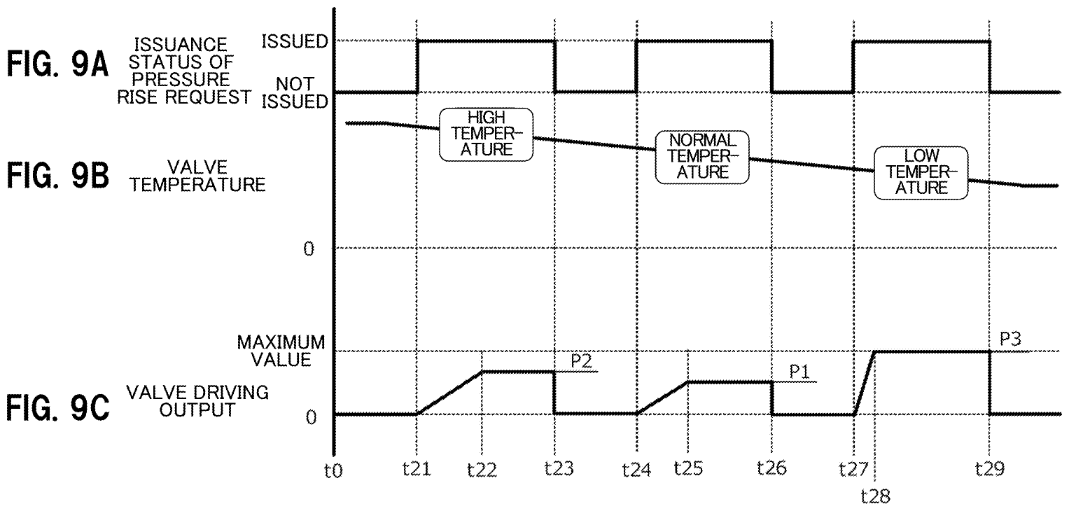

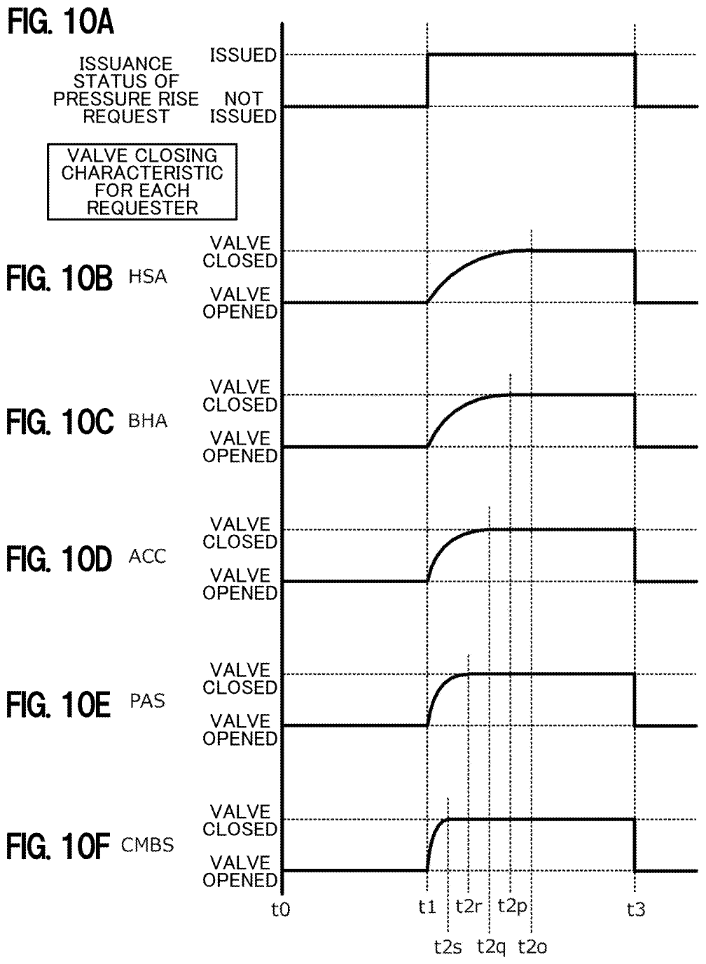

FIGS. 4A to 8C are time charts for describing the operations of the vehicle braking device 11 according to the embodiments of the present invention. FIGS. 9A to 9C are time charts depicting a way to change the valve closing characteristic depending on variations in the valve temperature of the first and second shutoff valves 60a and 60b. FIGS. 10A to 10F are time charts for describing an operation of a vehicle braking device 11 according to a modification of the embodiment of the present invention.

At time t1 in FIG. 4A, a pressure rise request is received from any of the multiple pressure rise requesters presumed by the present invention. Thus, the pressure rise request from any pressure rise requester is generated for a period from time t1 to time t3 (see FIG. 4A).

FIG. 4B depicts a time-series characteristic of a valve open-to-close state (valve closing characteristic) in the case where the requester of the pressure rise request issued at time t1 is the HSA (hill start assist). When the requester is the HSA, which requires the lowest level of immediate responsiveness, the valve closing is performed in a valve closing period from time t1 to time t2a with a linear characteristic relatively gently (see FIG. 4B).

FIG. AC depicts a valve closing characteristic in the case where the requester of the pressure rise request issued at time t1 is the BHA (brake hold assist). When the requester is the BHA, which requires the second lowest level of immediate responsiveness, the valve closing is performed in a valve closing period from time t1 to time t2b (where |t2b−t1|<|t2a−t1|) with a linear characteristic more rapidly than in the case of the HSA (see FIG. 4C).

FIG. 4D depicts a valve closing characteristic in the case where the requester of the pressure rise request issued at time t1 is the ACC (adaptive cruise control). When the requester is the ACC, which requires the third lowest level of immediate responsiveness, the valve closing is performed in a valve closing period from time t1 to time t2c (where |t2c−t1|<|t2b−t1|) with a linear characteristic more rapidly than in the case of the BHA (see FIG. 4D).

FIG. 4E depicts a valve closing characteristic in the case where the requester of the pressure rise request issued at time t1 is the PAS (parking assist system). When the requester is the PAS, which requires the second highest level of immediate responsiveness, the valve closing is performed in a valve closing period from time t1 to time t2d (where |t2d−t1|<|t2c−t1|) with a linear characteristic more abruptly than in the case of the ACC (see FIG. 4E).

FIG. 4F depicts a valve closing characteristic in the case where the requester of the pressure rise request issued at time t1 is the CMBS (collision damage mitigation brake system). When the requester is the CMBS, which requires the highest level of immediate responsiveness, the valve closing is performed in a valve closing period from time t1 to time t2e (where |t2e−t1|<|t2d-t1|) with a linear characteristic more abruptly than in the case of the PAS (see FIG. 4F).

In the embodiment depicted in FIGS. 4A to 4F, when a pressure rise request is received from any of the multiple pressure rise requesters (the HSA, the BHA, the ACC, the PAS, and the CMBS) presumed by the vehicle braking device 11 according to the embodiment of the present invention, the valve closing characteristic in the course of closing the first and second shutoff valves 60a and 60b from the time of reception of the pressure rise request is set such that the valve closing characteristic for the pressure rise request from the second group requester (the HSA, the BHA, or the ACC classified as the steady braking requester) is gentler than the valve closing characteristic for the pressure rise request from the first group requester (the PAS or the CMBS classified as the emergency braking requester).

In other words, in the embodiment depicted in FIGS. 4A to 4F, when a pressure rise request is received from any of the multiple pressure rise requesters (the HSA, the BHA, the ACC, the PAS, and the CMBS) presumed by the vehicle braking device 11 according to the embodiment of the present invention, the valve closing speed in the course of closing the first and second shutoff valves 60a and 60b from the time of reception of the pressure rise request is set such that the valve closing speed for the pressure rise request from the second group requester (the HSA, the BHA, or the ACC classified as the steady braking requester) is lower than the valve closing speed for the pressure rise request from the first group requester (the PAS or the CMBS classified as the emergency braking requester).

### Operation in the Case where an ACC's Pressure Rise Request and a CMBS's Pressure Rise Request are Issued in this Order with a Time Lag

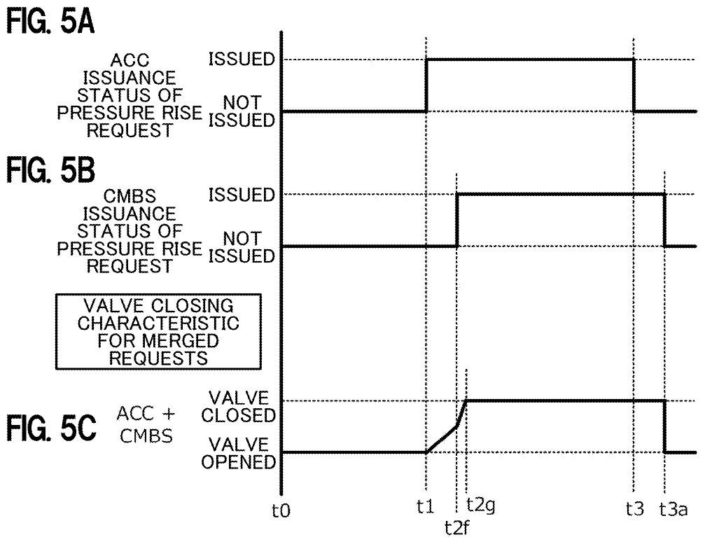

FIGS. 5A to 5C depict the case where an ACC's pressure rise request issued at time t1 and a CMBS's pressure rise request issued at time t2f have a time lag (when the CMBS's pressure rise request is issued later in the valve closing period for the ACC's pressure rise request), and depict a valve closing characteristic for these pressure rise requests merged.

At time t1 in FIG. 5A, an ACC's pressure rise request is received. Thus, the ACC's pressure rise request is issued for a period from time t1 to time t3 (see FIG. 5A).

At time t2f in FIG. 53, a CMBS's pressure rise request is received. Thus, the CMBS's pressure rise request is issued for a period from time t2f to time t3a (see FIG. 5B).

In this example, the valve closing is first performed in a valve closing period from time t1 to time t2f with a linear and relatively steep time-series characteristic (valve closing characteristic) set for the ACC's pressure rise request, and then the valve closing is performed in a valve closing period from time t2f to time t2g with a linear and relatively steep time-series characteristic (valve closing characteristic) set for the CMBS (which is steeper than that for the ACC) (see FIG. 5C).

In the case where the ACC's pressure rise request issued at time t1 in FIG. 5A and the CMBS's pressure rise request issued at time t2f in FIG. 5B have a time lag, the valve closing characteristic for the merged pressure rise requests is a characteristic with a different shape, that is, a letter-V shape bent at time t2f (see FIG. 5C).

It should be noted that the length of a period when the valves are kept closed in the valve closing characteristic for the merged pressure rise requests is set longer by a length of the time lag |t2f−t1| than the length of a period when the valves are kept closed in the case where the ACC's pressure rise request is issued alone.

In the embodiment depicted in FIGS. 5A to 5C, in the case where the pressure rise request is received from the CMBS classified as the emergency braking requester during execution of the steady braking control in response to the pressure rise request from the ACC classified as the steady braking requester, the valve closing characteristic for the pressure rise request issued by the steady braking requester (see the characteristic line in the valve closing period from time t1 to time t2f in FIG. 5C) is changed to the valve closing characteristic for the pressure rise request issued by the emergency braking requester (see the characteristic line in the valve closing period from time t2f to time t2g in FIG. 5C).

In the embodiment depicted in FIGS. 5A to 5C, in the case where the pressure rise request is received from the CMBS classified as the emergency braking requester during the execution of the steady braking control in response to the pressure rise request from the ACC classified as the steady braking requester, the valve closing characteristic for the pressure rise request issued by the ACC is switched over to the valve closing characteristic for the pressure rise request issued by the CMBS. The valve closing characteristic for the pressure rise request issued by the CMBS is steeper than the valve closing characteristic for the pressure rise request issued by the ACC.

According to the embodiment depicted in FIGS. 5A to 5C, the total valve closing period can be shorten compared with the case where the valve closing characteristic for the pressure rise request issued by the ACC is retained without being changed to the valve closing characteristic for the pressure rise request issued by the CMBS at a time when the later pressure rise request is received from the CMBS. In addition, since the changeover of the valve closing characteristic from the steady braking mode to the emergency braking mode can be quickly performed, the emergency braking operation can be performed as appropriate with good responsiveness.

### Operation in the Case where a CMBS's Pressure Rise Request and an ACC's Pressure Rise Request are Issued in this Order with a Time Lag

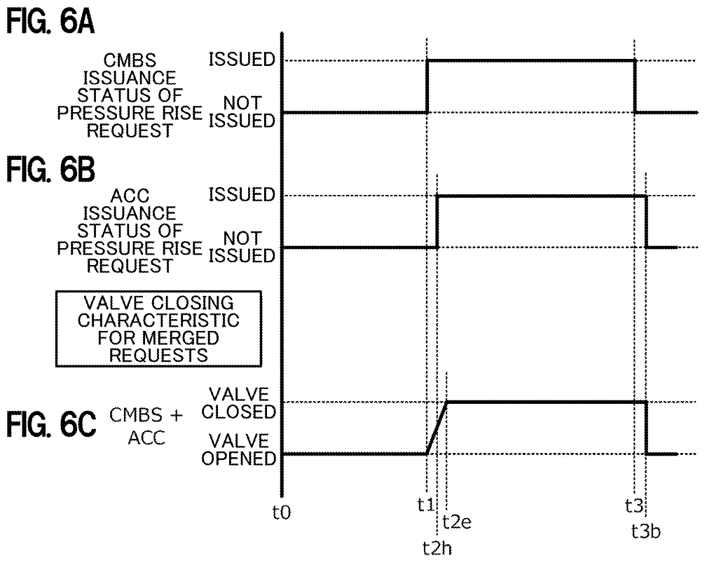

FIGS. 6A to 6C depict the case where a CMBS's pressure rise request issued at time t1 and an ACC's pressure rise request issued at time t2f have a time lag (when the ACC's pressure rise request is issued later in a valve closing period for the CMBS's pressure rise request), and depict a valve closing characteristic for these pressure rise requests merged.

At time t1 in FIG. 6A, a CMBS's pressure rise request is received. Thus, the CMBS's pressure rise request is issued for a period from time t1 to time t3 (see FIG. 6A).

At time t2h in FIG. 6B, an ACC's pressure rise request is received. Thus, the ACC's pressure rise request is issued for a period from time t2h to time t3b (see FIG. 6B).

In this example, the valve closing is performed in a valve closing period from time t1 to time t2e with a linear and relatively steep time-series characteristic (valve closing characteristic) set for the CMBS (which is steeper than that for the ACC) (see FIG. 6C).

In the case where the CMBS's pressure rise request issued at time t1 in FIG. 6A and the ACC's pressure rise request issued at time t2h in FIG. 6B have a time lag, the valve closing characteristic for the merged pressure rise requests is substantially the same as the characteristic in the case where the CMBS's pressure rise request is issued alone (see FIG. 6C).

It should be noted that the length of a period when the valves are kept closed in the valve closing characteristic for the merged pressure rise requests is set longer by a length of the time lag |t2h−t1| than the length of a period when the valves are kept closed in the case where the CMBS's pressure rise request is issued alone.

In the embodiment depleted in FIGS. 6A to 6C, in the case where the pressure rise request is received from the ACC classified as the steady braking requester during execution of the emergency braking control in response to the pressure rise request from the CMBS classified as the emergency braking requester, the valve closing characteristic for the pressure rise request issued by the emergency braking requester (see the characteristic line in the valve closing period from time t1 to time t2e in FIG. 6C) is retained as it is (without being changed to the valve closing characteristic for the pressure rise request issued by the steady braking requester).

According to the embodiment depicted in FIGS. 6A to 6C, since the valve closing characteristic for the pressure rise request issued by the CMBS is steeper than the valve closing characteristic for the pressure rise request issued by the ACC, the total valve closing period can be shorten compared with the case where the valve closing characteristic for the pressure rise request issued by the CMBS is changed to the valve closing characteristic for the pressure rise request issued by the ACC at a time when the later pressure rise request is received from the ACC.

In the embodiments depicted in FIGS. 4A to 6C described above, when a pressure rise request is received from any of the multiple pressure rise requesters (the HSA, the BHA, the ACC, the PAS, and the CMBS), the requester having issued the pressure rise request is recognized and the valve closing characteristic in the course of closing the first and second shutoff valves 60a and 60b from the time of reception of the pressure rise request from the recognized requester is set such that the valve closing characteristic for the pressure rise request from the second group requester (the HSA, the BHA, or the ACC classified as the steady braking requester) is gentler than the valve closing characteristic for the pressure rise request from the first group requester (the PAS or the CMBS classified as the emergency braking requester).

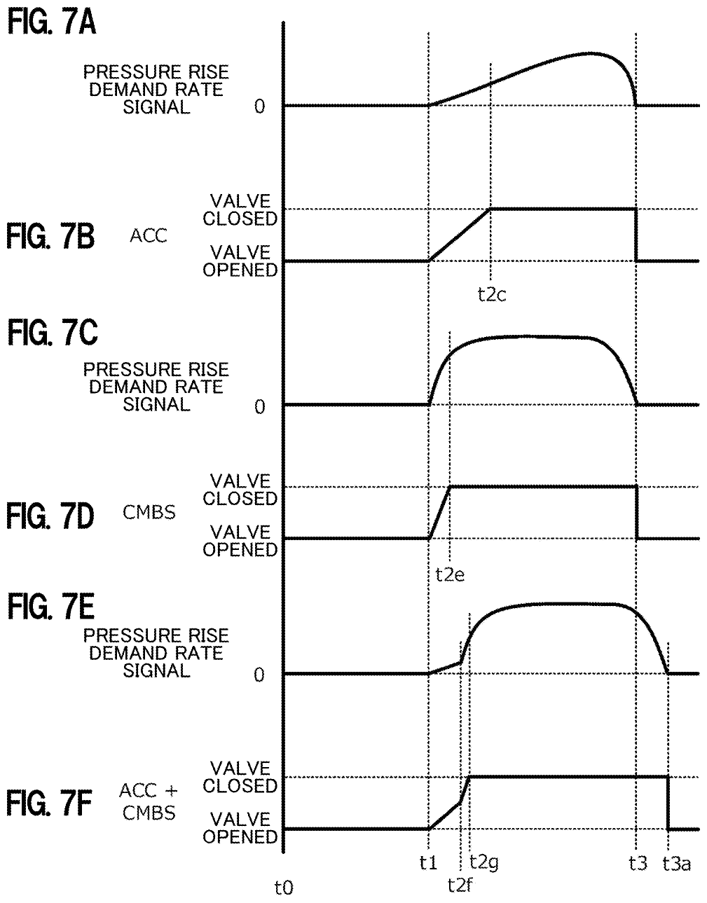

In contrast, in an embodiment depicted in FIGS. 7A to 7F, when a pressure rise request is received, a pressure rise demand rate signal indicating a time-series characteristic of a pressure rise demand level is recognized, and a valve closing characteristic in the course of closing the first and second shutoff valves 60a and 60b from the time of reception of the pressure rise request from the requester is set according to the recognized pressure rise, demand rate signal.

In a first example depicted in FIGS. 7A and 7B, a pressure rise demand rate signal having a time-series characteristic of a pressure rise demand level in a gently bulging shape depicted in FIG. 7A for a period from time t1 to time t3 is generated at time t1 in FIG. 7A (see FIG. 7A).

FIG. 7B depicts a valve closing characteristic according to the pressure rise demand rate signal generated for the period from time t1 to time t3 in FIG. 7A. In the embodiment depicted in FIG. 7B, the valve closing characteristic is the same as the valve closing characteristic in the case where the requester of the pressure rise request issued at time t1 is the ACC. In this case, the valve closing is performed in a valve closing period from time t1 to time t2c with a linear characteristic relatively rapidly (see FIG. 7B).

In a second example depicted in FIGS. 7C and 7D, a pressure rise demand rate signal having a time-series characteristic of a pressure rise demand level in a substantially trapezoidal shape depicted in FIG. 7C for the period from time t1 to time t3 is generated at time t1 in FIG. 7C (see FIG. 7C).

FIG. 7D depicts a valve closing characteristic according to the pressure rise demand rate signal generated for the period from time t1 to time t3 in FIG. 7C. In the embodiment, depicted in FIG. 7D, the valve closing characteristic is the same as the valve closing characteristic in the case where the requester of the pressure rise request issued at time t1 is the CMBS. In this case, the valve closing is performed in a valve closing period from time t1 to time t2e with a linear characteristic relatively abruptly (see FIG. 7D).

In a third example depicted in FIGS. 7E and 7F, for a period from time t1 to time t3a, a pressure rise demand rate signal is generated in which the pressure rise demand rate signal having the time-series characteristic of the pressure rise demand level in the gently bulging shape depicted in FIG. 7A and the pressure rise demand rate signal having the time-series characteristic of the pressure rise demand level in the substantially trapezoidal shape depicted in FIG. 7C are merged (see FIG. 7E).

FIG. 7F depicts a valve closing characteristic according to the pressure rise demand rate signal generated for the period from time t1 to time t3a in FIG. 7E. In the embodiment depicted in FIG. 7F, the valve closing characteristic is the same as the valve closing characteristic for the merged pressure rise requests in the case where the ACC's pressure rise request issued at time t1 in FIG. 7E and the CMBS's pressure rise request issued at time t2f in FIG. 7E have a time lag. The valve closing characteristic for the merged pressure rise requests is a characteristic in a different shape, that is, a letter-V shape bent at time t2f in FIG. 7F(see FIG. 7F).

It should be noted that the length of a period when the valves are kept closed in the valve closing characteristic for the merged pressure rise requests is set longer by a length of the time lag |t2f−t1| than the length of a period when the valves are kept closed in the case where the ACC's pressure rise request is issued alone.

According to the embodiment depicted in FIGS. 7A to 7F, when a pressure rise request is received, the pressure rise demand rate signal indicating the time-series characteristic of the pressure rise demand level is recognized, and the valve closing characteristic suitable for the pressure rise demand rate signal is set based on the recognized pressure rise demand rate signal. Therefore, as in the embodiments in FIGS. 4A to 6C, the operation sound (noise) associated with the valve closure of the first and second shutoff valves 60a and 60b can be suppressed as much as possible.

In an embodiment depicted in FIGS. 6A to 8C, the valve closing characteristic for the first and second shutoff valves 60a and 60b is set by using information on an issuance status of a pressure rise request and a pressure rise demand volume signal indicating a pressure rise demand volume.

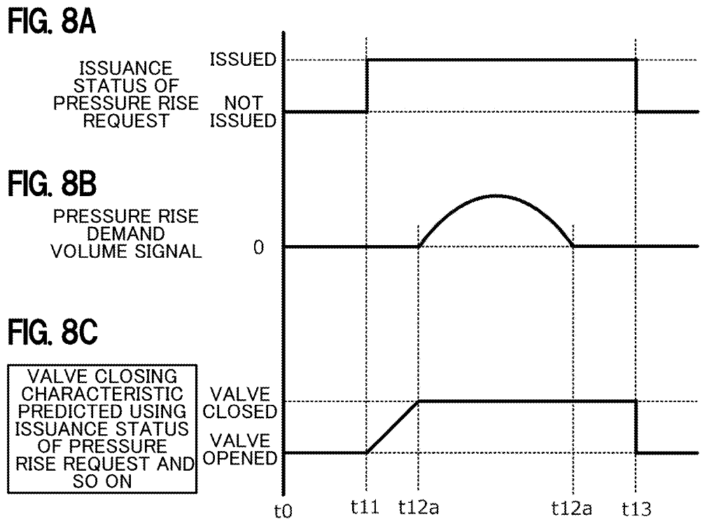

For a period from time t11 to time t13 in FIG. 8A, a pressure rise request is issued from a certain pressure rise requester (see FIG. 8A).

FIG. 8B depicts a time-series characteristic of a pressure rise demand volume for the pressure rise request issued in FIG. 8A. The pressure rise demand volume is generated in an arc shape from time t12a to time t12b in FIG. 8B.

In addition, FIG. 8C depicts a valve closing characteristic for the first and second shutoff valves 60a and 60b predicted by using the information on the issuance status of the pressure rise request and the pressure rise demand volume signal.

In the embodiment depicted in FIGS. 8A to 8C, if the valve closing characteristic for the first and second shutoff valves 60a and 60b is set with only the pressure rise demand volume signal in FIG. 8B taken into consideration, a problem of a temporal delay of the valve closing processing in response to the pressure rise request occurs.

To address this, in the embodiment depicted in FIG. 8C, the valve closing characteristic for the first and second shutoff valves 60a and 60b is predicted in advance by using the information on the issuance status of the pressure rise request and the pressure rise demand volume signal, so that a situation having a temporal delay of the valve closing processing in response to the pressure rise request is prevented from occurring

It should be noted that the configuration to predict the valve closing characteristic for the first and second shutoff valves 60a and 60b in advance in the embodiment depicted in FIG. 8C is also employed in the embodiments depicted in FIGS. 4A to 4F, 5A to 5C, and 7A to 7F.

In the vehicle braking device 11 according to the embodiment of the present invention, a valve temperature of the first and second shutoff valves 60a and 60b varies depending on conditions such as an ambient temperature of the outside air and the operation status of the in-vehicle engine. Accordingly, the value of the valve closing characteristic also varies depending on variations in the valve temperature of the first and second shutoff valves 60a and 60b. As a result, there is a concern that the valve closing characteristic set in the present invention may have an error.

To address this, in an embodiment depicted in FIGS. 9A to 9C, the valve closing characteristic suitable for the valve temperature of the first and second shutoff valves 60a and 60b is set depending on a variation in the valve temperature.

At normal temperature in FIG. 9B, the valve closing operation of the first and second shutoff valves 60a and 60b is preformed relatively smoothly (with agility). This is because the first and second shutoff valves 60a and 60b are usually designed based on the normal temperature such that the smooth valve closing operation (with agility) can be achieved.

For this reason, a valve driving output necessary to close the first and second shutoff valves 60a and 60b is set relatively low at the normal temperature in FIG. 9B.

At the normal temperature in FIG. 9B, a pressure rise request is issued for a period from time t24 to time t26. For a valve closing period from time t24 to time t25 within the period from time t24 to time t26, the valve closing is performed with a linear and relatively gentle valve driving output characteristic (valve closing characteristic) set for the pressure rise request (see FIG. 9C).

It should be noted that the valve driving output value for a period when the valves are kept closed (valve closure keeping period) at the normal temperature is a lower value P1 than valve driving output values P2 and P3 for valve closure keeping periods at high temperature and low temperature.

At the high temperature in FIG. 9B, the valve closing operation of the first and second shutoff valves 60a and 60b is performed more dully than at the normal temperature.

For this reason, at the high temperature in FIG. 9B, the valve driving output necessary to close the first and second shutoff valves 60a and 60b is set higher than that at the normal temperature.

At the high temperature in FIG. 9B, a pressure rise request is issued for a period from time t21 to time t23. For a valve closing period from time t21 to time t22 within the period from time t21 to time t23, the valve closing is performed with a linear and relatively gentle valve driving output characteristic (valve closing characteristic) set for the pressure rise request (see FIG. 9C).

It should be noted that the valve driving output value for the valve closure keeping period at the high temperature is the value P2 intermediate between the valve driving output values P1 and P3 for the valve closure keeping periods at the normal temperature and the low temperature.

At the low temperature in FIG. 9B, the valve closing operation of the first and second shutoff valves 60a and 60b is performed more dully than at the normal temperature and the high temperature.

For this reason, at the low temperature in FIG. 9B, the valve driving output necessary to close the first and second shutoff valves 60a and 60b is set higher than those at the normal temperature and the high temperature.

At the low temperature in FIG. 9B, a pressure rise request is issued for a period from time t27 to time t29. For a valve closing period from time t27 to time t28 within the period from time t27 to time t29, the valve closing is performed with a linear and relatively steep valve driving output characteristic (valve closing characteristic) set for the pressure rise request (see FIG. 9C).

It should be noted that the valve driving output value for the valve closure keeping period at the low temperature is the value P3 higher than the valve driving output values P1 and P2 for the valve closure keeping periods at the normal temperature and the high temperature.

According to the embodiment in FIGS. 9A to 9C, the valve closing characteristic suitable for the valve temperature of the first and second shutoff valves 60a and 60b is set depending on a variation in the valve temperature, so that the noise associated with the closure of the first and second shutoff valves 60a and 60b can be appropriately suppressed even if the valve temperature varies.

Next, with reference to FIGS. 10A to 10F, description is provided for a modification of the embodiment depicted in FIGS. 4A to 4F.

In the embodiment depicted in FIGS. 4A to 4F, when a pressure rise request is received from any of the multiple pressure rise requesters (the HSA, the BHA, the ACC, the PAS, and the CMBS), the requester having issued the pressure rise request is recognized, and the valve closing characteristic in the course of closing the first and second shutoff valves 60a and 60b from the time of reception of the pressure rise request from the recognized requester is set such that the valve closing characteristic for the pressure rise request from the second group requester (the HSA, the BHA, or the ACC classified as the steady braking requester) is gentler than the valve closing characteristic for the pressure rise request from the first group requester (the PAS or the CMBS classified as the emergency braking requester).

More specifically, both the valve closing characteristic for the pressure rise request issued by the first group requester and the valve closing characteristic for the pressure rise request issued by the second group requester are linear time-series characteristics in the embodiment depicted in FIGS. 4A to 4F.

In contrast to this, in the embodiment depicted in FIGS. 10A to 10F, both the valve closing characteristic for the pressure rise request issued by the first group requester and the valve closing characteristic for the pressure rise request issued by the second group requester are non-linear time-series characteristics.

More specifically, in the embodiment depicted in FIGS. 10A to 10F, both the valve closing speed for the pressure rise request issued by the first group requester and the valve closing speed for the pressure rise request issued by the second group requester are set such that the valve closing speed at a time close to closure of the first and second shutoff valves 60a and 60b is lower than the valve closing speed at a time close to reception of a pressure rise request.

At time t1 in FIG. 10A, a pressure rise request is received from any of the multiple pressure rise requesters presumed by the present invention. Thus, the pressure rise request from the pressure rise requester is issued for a period from time t1 to time t3 (see FIG. 10A).

FIG. 10B depicts a valve closing characteristic in the case where the requester of the pressure rise request issued at time t1 is the HSA (hill start assist). When the requester is the HSA, which requires the lowest level of immediate responsiveness, the valve closing is performed in a valve closing period from time t1 to time t2o relatively gently with a non-linear characteristic in which the valve closing speed becomes gradually lower with the lapse of time from the valve opened state to the valve closed state (see FIG. 10B).

FIG. 10C depicts a valve closing characteristic in the case where the requester of the pressure rise request issued at time t1 is the BHA (brake hold assist). When the requester is the BHA, which requires the second lowest level of immediate responsiveness, the valve closing is performed in a valve closing period from time t1 to time t2p (where |t2p−t1|<|t2o−t1|) with a non-linear characteristic in which the valve closing speed becomes gradually lower with the lapse of time from the valve opened state to the valve closed state, more rapidly than in the case of the HSA (see FIG. 10C).

FIG. 10D depicts a valve closing characteristic in the case where the requester of the pressure rise request issued at time t1 is the ACC (adaptive cruise control). When the requester is the ACC, which requires the third lowest level of immediate responsiveness, the valve closing is performed in a valve closing period from time t1 to time t2q (where |t2q−t1|<|t2p−t1|) with a non-linear characteristic in which the valve closing speed becomes gradually lower with the lapse of time from the valve opened state to the valve closed state, more rapidly than in the case of the BHA (see FIG. 10D).

FIG. 10E depicts a valve closing characteristic in the case where the requester of the pressure rise request issued at time t1 is the PAS (parking assist system). When the requester is the PAS, which requires the second highest level of immediate responsiveness, the valve closing is performed in a valve closing period from time t1 to time t2r (where |t2r−t1|<|t2q−t1|) with a non-linear characteristic in which the valve closing speed becomes gradually lower with the lapse of time from the valve opened state to the valve closed state, more abruptly than in the case of the ACC (see FIG. 10E).

FIG. 10F depicts a valve closing characteristic in the case where the requester of the pressure rise request issued at time t1 is the CMBS (collision damage mitigation brake system). When the requester is the CMBS, which requires the highest level of immediate responsiveness, the valve closing is performed in a valve closing period from time t1 to time t2s (where |t2s−t1|<|t2r−t1|) with a non-linear characteristic in which the valve closing speed becomes gradually lower with the lapse of time from the valve opened state to the valve closed state, more abruptly than in the case of the PAS (see FIG. 10F).

Since the embodiment depicted in FIGS. 10A to 10F (the modification of the embodiment depicted in FIGS. 4A to 4F) employs the non-linear valve closing characteristic in which the valve closing speed becomes gradually lower with the lapse of time from the valve opened state to the valve closed state, the effect of suppressing the noise associated with the closure of the first and second shutoff valves 60a and 60b is further enhanced than in the embodiment depicted in FIGS. 4A to 4F which employs the linear valve closing characteristic.

### Operations and Effects of the Vehicle Braking Device 11 According to the Embodiments of the Present Invention

Next, description is provided for the operations and effects of the vehicle braking device 11 according to the embodiments of the present invention.

The vehicle braking device 11 based on a first aspect (corresponding to claim 1) applies braking force to a host vehicle and employs the following configuration. Specifically, the vehicle braking device 11 includes: the master cylinder device 14 which generates the primary hydraulic pressure according to a braking operation by the driver of the host vehicle; the motor cylinder device 16 which generates the secondary hydraulic pressure according to target braking force by an operation of the brake motor 72 and the pump motor 77 (electric actuator); and the first; and second shutoff valves 60a and 60b (solenoid valves) of the normally-open type which are provided in the piping tubes 22a and 22d (hydraulic pressure passages) providing communication between the master cylinder device 14 and the motor cylinder device 16 and which operate to open or close the hydraulic pressure passages; and the integrated control unit 175 (control unit) which performs drive control to close the solenoid valves in response to a pressure rise request. The requesters to issue pressure rise requests include the first group requester in the first group which requires relatively high responsiveness and a second group requester in the second group which tolerates relatively low responsiveness. When a pressure rise request is received from any one of the first group requester and the second group requester, the integrated control unit 175 sets a valve closing characteristic in the course of closing the solenoid valves from the time of reception of the pressure rise request such that the valve closing characteristic for the pressure rise request issued by the second group requester is gentler than the valve closing characteristic for the pressure rise request issued by the first group requester.

According to the vehicle braking device 11 based on the first aspect, the integrated control unit 175 sets the valve closing characteristic for the pressure rise request issued by the second group requester which tolerates relatively low responsiveness to be gentler than the valve closing characteristic for the pressure rise request issued by the first group requester which requires relatively high responsiveness. Thus, the noise associated with the closure of the solenoid valves in implementing the autonomous braking control function can be suppressed as much as possible.

The vehicle braking device 11 based on a second aspect (corresponding to claim 2) is the vehicle braking device 11 based on the first aspect, employing a configuration in which, when a pressure rise request is received from any one of the first group requester and the second group requester, the integrated control unit 175 sets a valve closing speed in the course of closing the solenoid valves from the time of reception of the pressure rise request such that the valve closing speed for the pressure rise request issued by the second group requester is lower than the valve closing speed for the pressure rise request issued by the first group requester.

According to the vehicle braking device 11 based on the second aspect, the integrated control unit 175 sets the valve closing speed for the pressure rise request issued by the second group requester which tolerates relatively low responsiveness to be lower than the valve closing speed for the pressure rise request issued by the first group requester which requires relatively high responsiveness. Thus, the noise associated with the closure of the solenoid valves in implementing the autonomous braking control function can be suppressed as much as possible as is the case with the vehicle braking device 11 based on the first aspect.

The vehicle braking device 11 based on a third aspect (corresponding to claim 3) is the vehicle braking device 11 based on the second aspect, employing a configuration in which the integrated control unit 175 sets the valve closing speed such that the valve closing speed at a time close to closure of the solenoid valves is lower than the valve closing speed at a time close to reception of a pressure rise request.

According to the vehicle braking device 11 based on the third aspect, the integrated control unit 175 sets the valve closing speed such that the valve closing speed at a time close to closure of the solenoid valves is lower than the valve closing speed at a time close to reception of a pressure rise request. Thus, the effect of suppressing the noise associated with the closure of the solenoid valves can be further enhanced than in the vehicle braking device 11 based on the first and second aspects.

The vehicle braking device 11 based on a fourth aspect (corresponding to claim 4) is the vehicle braking device 11 based on the first to third aspects, employing a configuration in which an emergency braking requester which requests emergency braking intended to mitigate a collision damage is classified as the first group requester and a steady braking requester which requests steady braking intended to steadily keep a stoppage and a constant speed running state of the host vehicle is classified as the second group requester.

According to the vehicle braking device 11 based on the fourth aspect, the emergency braking requester which requests emergency braking intended to mitigate a collision damage is classified as the first group requester and the steady braking requester which requests steady braking intended to steadily keep a stoppage and a constant speed running state of the host vehicle is classified as the second group requester. Thus, the priority levels of the pressure rise requesters in terms of the responsiveness can be identified to make clear what valve closing characteristic should be set for a pressure rise request(s).

The vehicle braking device 11 based on a fifth aspect (corresponding to claim 5) is the vehicle braking device 11 based on the fourth aspect, employing a configuration in which the emergency braking requester includes the collision damage mitigation controller 185 which performs control to mitigate a collision damage of the host vehicle.

According to the vehicle braking device 11 based on the fifth aspect, the emergency braking requester includes the collision damage mitigation controller 185 which performs control to mitigate a collision damage of the host vehicle, so that requesters to be classified into the group of emergency braking requesters being high in the high priority levels of the pressure rise requesters in terms of the responsiveness can be clearly defined to make clear the application range of the present invention.

The vehicle braking device 11 based on a sixth aspect (corresponding to claim 6) is the vehicle braking device 11 based on the fourth aspect, employing a configuration in which the steady braking requester includes the constant speed running controller 183 which performs control to steadily keep the vehicle speed of the host vehicle at the preset target vehicle speed, and the stoppage keeping controller 181 which performs control to steadily keep the stopped host vehicle in the stopped state. When a pressure rise request is received from a steady braking requester, the integrated control unit 175 sets the valve closing characteristic in the course of closing the solenoid valves from the time of reception of the pressure rise request such that the valve closing characteristic for the pressure rise request issued by the stoppage keeping controller 181 is gentler than the valve closing characteristic for the pressure rise request issued by the constant speed running controller 183.

According to the studies of the present inventors, it has been found that a passenger in the host vehicle feels noisier against the noise associated with the closure of the solenoid valves in the case where the host vehicle is stopped than in the case where the host vehicle is running.

According to the vehicle braking device 11 based on the sixth aspect, when a pressure rise request is received from a steady braking requester, the integrated control unit 175 sets the valve closing characteristic for the pressure rise request issued by the stoppage keeping controller 181 to be gentler than the valve closing characteristic for the pressure rise request issued by the constant speed running controller 183, so that the effect of suppressing the noise associated with the closure of the solenoid valves in the case where the host vehicle is stopped can be further enhanced.

The vehicle braking device 11 based on a seventh aspect (corresponding to claim 7) is the vehicle braking device 11 based on the fourth aspect, employing a configuration in which, when a pressure rise request is received from a steady braking requester, the integrated control unit 175 performs drive control to close the solenoid valves prior to execution of the braking control on the host vehicle.

According to the vehicle braking device 11 based on the seventh aspect (corresponding to claim 7), when a pressure rise request is received from a steady braking requester, the integrated control unit 175 performs drive control to close the solenoid valves prior to execution of the braking control on the host vehicle. Thus, since the solenoid valves are closed prior to the execution of the braking control on the host vehicle, a wide dynamic range of the valve closing characteristic for the solenoid valves can be achieved.

According to the vehicle braking device 11 based on the seventh aspect (corresponding to claim 7), when a pressure rise request is received from a steady braking requester, the solenoid valves are closed prior to the execution of the braking control, which makes it possible to achieve a wide dynamic range of the valve closing characteristic for the solenoid valves. Thus, the effect of suppressing the noise associated with the closure of the solenoid valves can be further enhanced than in the vehicle braking device 11 based on the fourth aspect.

In addition, since it is easier to know in advance the time of closing the solenoid valves in the case where a pressure rise request is received from a steady braking requester than in the case where a pressure rise request is received from an emergency braking requester, the solenoid valves can be closed at an appropriate time, which can be also expected to produce the effect of enabling appropriate braking control.

The vehicle braking device 11 based on an eighth aspect (corresponding to claim 8) is the vehicle braking device 11 based on the fourth aspect, employing a configuration in which, when a pressure rise request is received from an emergency braking requester during execution of steady braking control in response to a pressure rise request from a steady braking requester, the integrated control unit 175 changes over from the valve closing characteristic for the pressure rise request issued by the steady braking requester to the valve closing characteristic for the pressure rise request issued by the emergency braking requester.

According to the vehicle braking device 11 based on the eighth aspect (corresponding to claim 8), when a pressure rise request is received from an emergency braking requester during execution of steady braking control in response to a pressure rise request from a steady braking requester, the integrated control unit 175 changes over from the valve closing characteristic for the pressure rise request issued by the steady braking requester to the valve closing characteristic for the pressure rise request issued by the emergency braking requester. This can be expected to produce the effect of enhancing the responsiveness for the emergency braking control having a higher priority level than the steady braking control when the pressure rise request is received from the emergency braking requester during execution of the steady braking control.

The vehicle braking device 11 based on a ninth aspect (corresponding to claim 9) is the vehicle braking device 11 based on the fourth aspect, employing a configuration in which, when a pressure rise request is received from a steady braking requester during execution of emergency braking control in response to a pressure rise request from an emergency braking requester, the integrated control unit 175 retains the valve closing characteristic for the pressure rise request issued by the emergency braking requester.

According to the vehicle braking device 11 based on the ninth aspect (corresponding to claim 9), when a pressure rise request is received from a steady braking requester during execution of emergency braking control in response to a pressure rise request from an emergency braking requester, the integrated control unit 175 retains the valve closing characteristic for the pressure rise request issued by the emergency braking requester. This can be expected to produce the effect of maintaining the responsiveness for the emergency braking control having a higher priority level than the steady braking control when the pressure rise request is received from the steady braking requester during execution of the emergency braking control.

### Other Embodiments

The embodiments described above are just examples illustrating the specific embodiments of the present invention. Therefore, the technical scope of the present invention should not be understood in a way limited by these embodiments. This is because the present invention can be carried out in various modes without departing from the spirit and the main features of the present invention.

For example, the embodiment depicted in FIGS. 7A to 7F is described by taking the example in which the valve closing characteristic suitable for the pressure rise demand rate signal is set according to the pressure rise demand rate signal, but the present invention is not limited to this example.

The present invention may use information indicating an amount of brake fluid consumed or a pressure rise level instead of the pressure rise demand rate signal.

What is claimed is:

1. A vehicle braking device which applies braking force to a host vehicle, comprising:
a master cylinder device which generates a primary hydraulic pressure according to a braking operation by a driver of the host vehicle;
a motor cylinder device which generates a secondary hydraulic pressure according to target braking force by an operation of an electric actuator;
a solenoid valve of a normally-open type which is provided in a hydraulic pressure passage providing communication between the master cylinder device and the motor cylinder device, and which operates to open or close the hydraulic pressure passage; and
a control unit which performs drive control to close the solenoid valve in response to each pressure rise request, wherein
requesters to issue the pressure rise requests include a first group requester in a first group which requires relatively high responsiveness and a second group requester in a second group which tolerates relatively low responsiveness, and
when a pressure rise request is received from any one of the first group requester and the second group requester, the control unit sets a valve closing characteristic in course of closing the solenoid valve from a time of reception of the pressure rise request such that the valve closing characteristic for the pressure rise request issued by the second group requester is gentler than the valve closing characteristic for the pressure rise request issued by the first group requester.

2. The vehicle braking device according to claim 1, wherein
when a pressure rise request is received from any one of the first group requester and the second group requester, the control unit sets a valve closing speed in the course of closing the solenoid valve from the time of reception of the pressure rise request such that the valve closing speed for the pressure rise request issued by the second group requester is lower than the valve closing speed for the pressure rise request issued by the first group requester.

3. The vehicle braking device according to claim 2, wherein the control unit sets the valve closing speed such that the valve closing speed at a time close to the closure of the solenoid valve is lower than the valve closing speed at a time close to the reception of the pressure rise request.

4. The vehicle braking device according to claim 1, wherein
an emergency braking requester which requests emergency braking intended to mitigate a collision damage is classified as the first group requester, and
a steady braking requester which requests steady braking intended to steadily keep a stoppage and a constant speed running state of the host vehicle is classified as the second group requester.

5. The vehicle braking device according to claim 4, wherein the emergency braking requester includes a collision damage mitigation controller which performs control to mitigate a collision damage of the host vehicle.

6. The vehicle braking device according to claim 4, wherein
the steady braking requester includes a constant speed running controller which performs control to steadily keep a vehicle speed of the host vehicle at a preset target vehicle speed, and a stoppage keeping controller which performs control to steadily keep the stopped host vehicle in a stopped state, and
when a pressure rise request is received from the steady braking requester, the control unit sets the valve closing characteristic in the course of closing the solenoid valve from the time of reception of the pressure rise request such that the valve closing characteristic for the pressure rise request issued by the stoppage keeping controller is gentler than the valve closing characteristic for the pressure rise request issued by the constant speed running controller.

7. The vehicle braking device according to claim 4, wherein
when a pressure rise request is received from the steady braking requester, the control unit performs drive control to close the solenoid valve prior to execution of braking control on the host vehicle.

8. The vehicle braking device according to claim 4, wherein
when a pressure rise request is received from the emergency braking requester during execution of steady braking control in response to a pressure rise request from the steady braking requester, the control unit changes over from the valve closing characteristic for the pressure rise request issued by the steady braking requester to the valve closing characteristic for the pressure rise request issued by the emergency braking requester.

9. The vehicle braking device according to claim 4, wherein
when a pressure rise request is received from the steady braking requester during execution of emergency braking control in response to a pressure rise request from the emergency braking requester, the control unit retains the valve closing characteristic for the pressure rise request issued by the emergency braking requester.
